(19) United States
(12) Patent Application Publication
(10) Pub. No.: US 2009/0096217 A1
(43) Pub. Date: Apr. 16, 2009

(54) Wind turbine with perimeter power takeoff

(76) Inventor: William Kemper Watson, Seattle, WA (US)

Correspondence Address: William K. Watson, 5409 Denver Ave S, Seattle, WA, 98108, US

(21) Appl. No.: 11/895,296

(22) Filed: Oct. 15, 2007

(51) Int. Cl. F03D 11/00; F03D 9/00

(52) U.S. Cl. 290/55; 416/142

(57) ABSTRACT

The horizontal axis wind turbine of this invention has a space frame structure that enables a light weight blade system to force rotation of numerous small wheels into rolling contact with the surface of at least one ring that extends around the perimeter of said blade system. A portion of the wheels drive rotation of multiple small electrical generators, and air compressors (?), at a high initial RPM, in the numbers needed to produce this wind turbine's useful power output.

For offshore use, a wind turbine structure as described above surmounts two horizontal toroidal members held apart by multiple vertical columns. The lower toroidal member and the vertical columns above this member float at a depth that is nearly half the column heights. Added structure enables the extraction of energy from waves transiting the vertical columns.

### FIELD OF INVENTION

This invention relates to wind turbines, and in particular to horizontal axis type wind turbines of large diameter.

### BACKGROUND OF THE INVENTION—PRIOR ART

Conventional large horizontal axis wind turbines employ two or three long, slender blades cantilevered out from a central, horizontal axle that in turn is raised high in the air atop a tall, slender tower that cantilevers up from the earth's surface. One result: a small transverse wind force, X, exerted at the tip of a blade will create large (≈30X) tension (upwind) and compression (downwind) stress loads that the entire lengths of both blades and tower must be able to withstand.

Furthermore, in a conventional horizontal axis wind turbine, power is taken off at the axis of blade rotation, at an RPM that must vary inversely with blade length to avoid an excessive tip speed. The lower RPM associated with greater blade length requires a proportionately heavier axis bearing to support blade rotation, and a heavier gearbox, or if gearless, a larger and heavier generator structure, to produce energy at the power line frequency.

Wind turbine U.S. Pat. No. 4,417,853, drawing #12 (copy enclosed) shows two potential means for reducing the cost of extracting energy from the wind: 1) Small wheels at the turbine perimeter take off the useful power output from the wind at an initial RPM far higher than the RPM of blade rotation. 2) Upwind perimeter “stay” cables withstand the wind force exerted on the blade area with far less stress than the stress levels experienced by cantilever beam blades sweeping through the same area. However, the intricate cloth blade furling system shown in U.S. Pat. No. 4,417,853 has not proven suitable for large wind turbines.

### SUMMARY OF THE INVENTION

To make possible a much larger power output, the present invention replaces the furling cloth sails of U.S. Pat. No. 4,417 853, with blades having a more conventional airfoil shape, that are supported within a surrounding structure which can counter wind force exerted on the blades with far less weight than is needed by the conventional combination of cantilever beam blades, set atop a cantilever beam type tower.

In a preferred option, the airfoil shaped blades of this invention extend from a common center of rotation, out to the inner ring of two concentric, nested rings. The inner ring attached to the blades is able to move smoothly through the interior of the outer nested ring by means of a rolling contact of the inner ring with a sufficient number of wheel mounted tires that drive rotation of multiple generators, and air compressors (?) mounted at intervals around the internal surface of the outer nested ring. This enables producing a useful power output at a far higher initial RPM than the RPM of blade rotation, in response to the wind's force.

Individual blades as used in this invention can range in design from simple, impact air inflated, cloth airfoils whose angle of incidence to local airflow cannot be changed, to multiple, tandem, rigid airfoil segments, each of whose trailing edge flaps can be rotated in unison by a central actuator, to a common angle of attack to local airflows, as a means of maximizing recovery of energy from wind transiting the blade system. (Impact air inflated cloth airfoils have the advantage of weighing a tiny fraction of the weight needed for cantilever beam blades, and are easily made retractable for protection from severe weather.)

“Stay” cables extend from between adjacent segments of the light weight airfoils made possible by this invention, fore and aft to ancillary structure having the depth and arrangement needed to directly absorb the axial force that the wind exerts oh the blade system, with far less stress than is experienced by the blades of a cantilever beam blade system.

The space frame type structure for wind turbines as described in this invention, will greatly reduce the structural weight now needed to extract energy from the wind, and may enable the construction of wind turbines of much larger blade swept area than those currently available, that can intercept the wind at an increased height above ground level where the wind typically has a greater energy content.

Other features and advantages of the invention will be apparent from the following detailed description, taken in conjunction with the accompanying drawings.

### BRIEF DESCRIPTION OF THE DRAWINGS

FIG. 1, a side view of the wind turbine of this invention, illustrates that a substantial land area is needed for its deployment, in order to achieve a much lighter structure.

FIG. 2 is a partial longitudinal section, showing how a single turbine blade is supported in order to drive rotation of multiple generators mounted out along this wind turbine's circumference

FIG. 3 is a frontal view of the wind turbine, showing means for supporting nested perimeter rings in a vertical position, to enable their rotation in azimuth, into the current wind direction.

FIG. 4 shows a sea going version of this invention, with modifications that allow the wind turbine of this invention to operate in this more challenging environment.

FIG. 5 shows how a central actuator can cause multiple blade segment trailing edge flaps to rotate all segments to a uniform angle of attack to each segment's own, local airflow.

FIG. 6 shows how retractable air impact inflated blades can cover much smaller chord biplane blades, to better cope with a wide range of wind speeds and weather conditions.

FIG. 7 compares the stress levels experienced by a cantilever beam type wind turbine blade, with the stress levels experienced by the equivalent structure of this invention.

Final FIG. 12 is reproduced from U.S. Pat. No. 4,417,853, with additions to this figure to emphasize elements of U.S. Pat. No. 4,417,853 that are pertinent to the present invention.

### DETAILED DESCRIPTION OF THE INVENTION

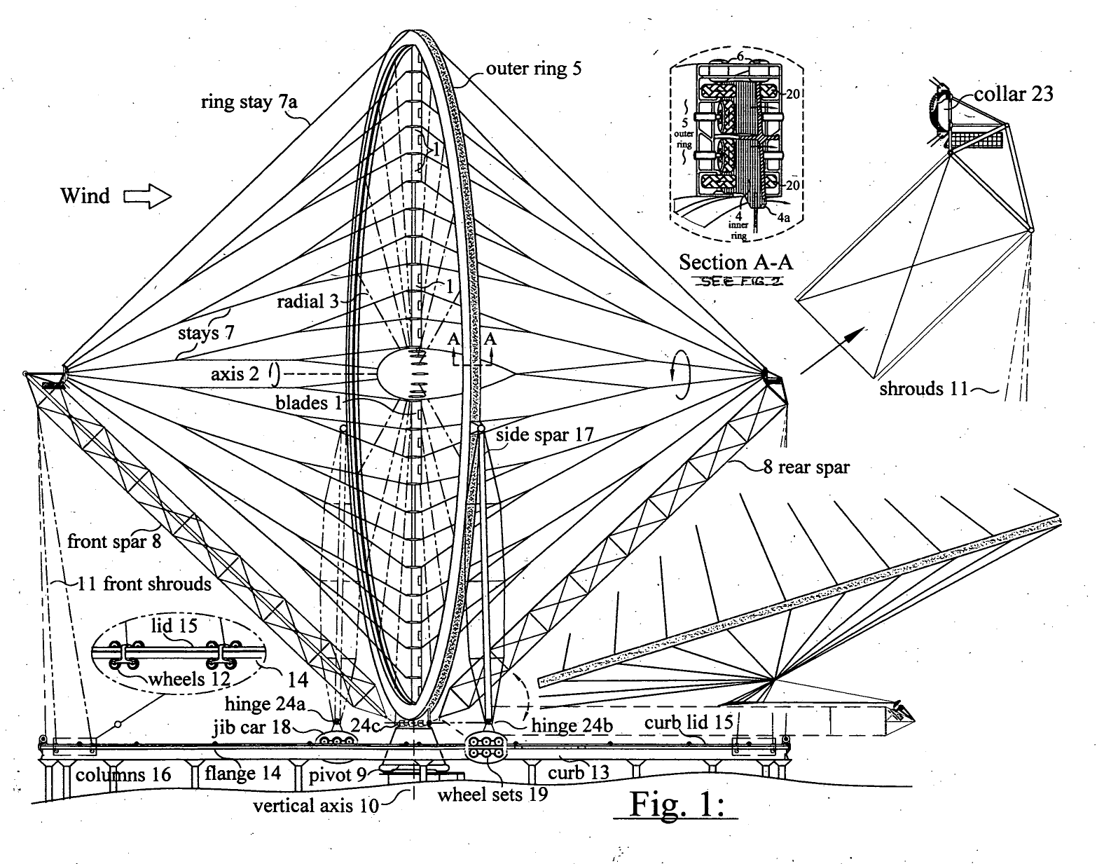

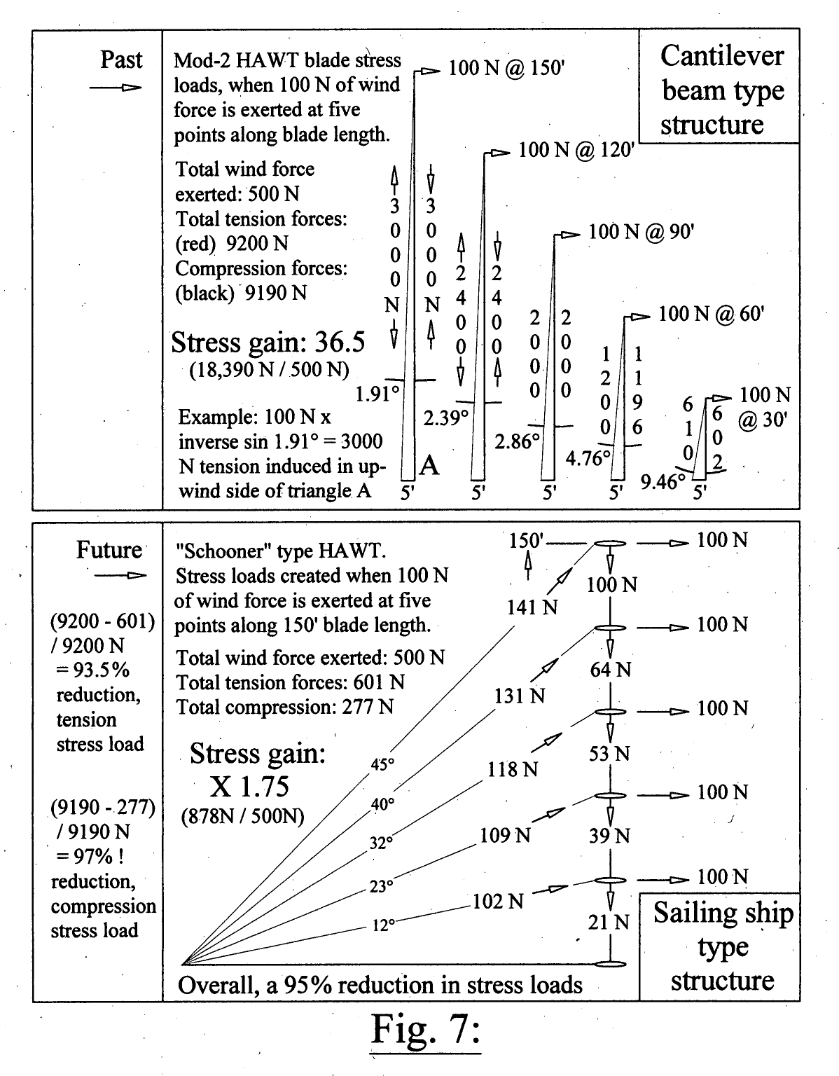

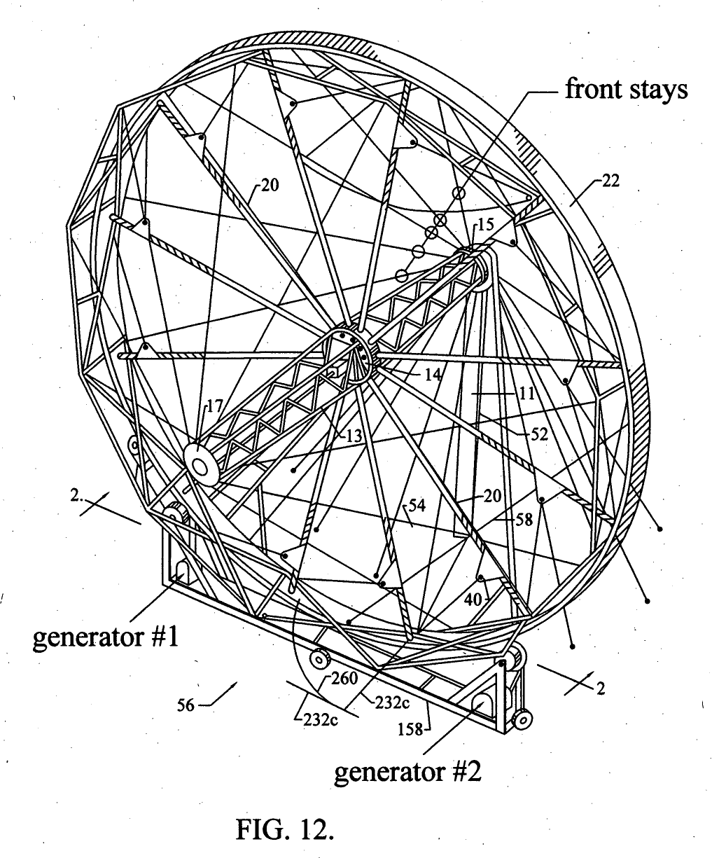

As shown in FIG. 1, the present invention is a cable-stayed, space frame-type horizontal axis wind turbine whose base extends out over a far larger area, land or sea, than is needed for base installation for a conventional horizontal axis wind turbine. FIG. 7 incorporates a stress analysis explaining why this broad base enables a major reduction in wind turbine stress loads developed in response to wind force.

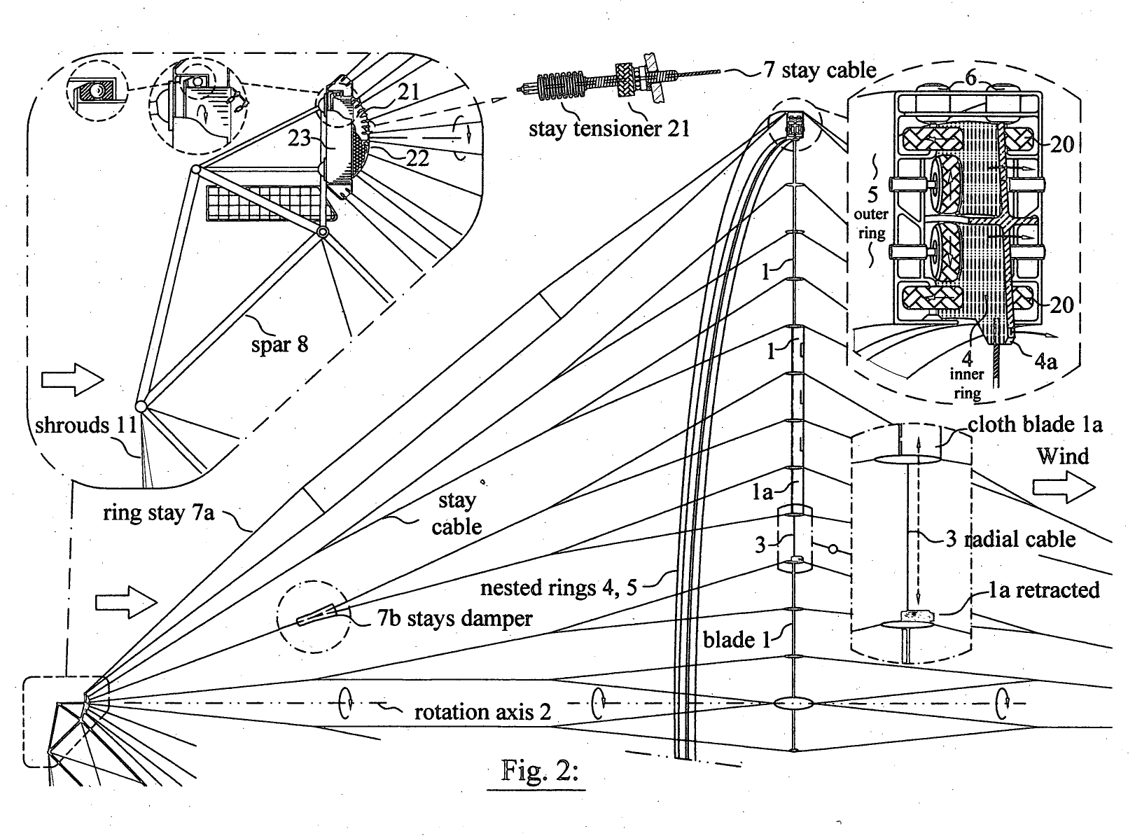

FIG. 1, and in more detail FIG. 2, show how a radial array of blades segments 1 can extend from a horizontal axis of rotation 2, out along radial cables 3, to an inner ring 4 (see FIG. 2) that moves through the interior of outer ring 5 in pace with the rotation of blade segments 1, in order to force the rotation of electrical generators 6, and air compressors?, mounted circumferentially along the interior of outer ring 5, at an initial RPM that can be 100 or more times the RPM of blade system rotation.

FIG. 1 illustrates that this major reduction in wind induced stress loads will require a base structure extending over a far larger land area that is occupied by the footing for a conventional HAWT, but can do so with little interference to the use of this same land area for farming and ranching.

In FIGS. 1 and 2, wind force exerted on the blade system is reacted primarily by stays 7 that extend from multiple points along blade segments 1, to the upper ends of fore and aft spars 8, whose lower ends rest on a central pivot 9, itself located at the ground level intercept of vertical axis line 10, around which nested blade rings 4, 5 rotate in azimuth to stay headed into the current wind direction.

Shroud cables 11 prevent spars 8 from being pulled upward by stay cable tension, by pulling upward on wheels 12 that roll in an inverted position along a suitable downward facing surface of flange 14 molded into curb 13. Curb 13 is elevated on columns 16 to free the local land surface for use in farming and ranching. Curb lid 15 serves to keep the various elements riding the curb moving in unison, and also keeps the curb top clean.

In FIG. 1, rings 4 and 5 are further supported for operation in a vertical position by lateral side spars 17 whose lower ends rest on jib cars 18. Jib cars 18 use opposing wheels sets 19 to secure the lower ends of side spars 17 to suitable surfaces of curb 13. Wheel sets 19 then allow rotation of side spars 17, along with the blade system, into the current wind direction.

FIG. 2 depicts in more detail one of the many alternatives for blade structure that are made possible by this invention. In FIG. 2, multiple light weight airfoils are supported. Sequentially as blade segments 1, along radial cables 3 that extend from a common horizontal axis of rotation 2, out through the length of blade segments 1, to a lug 4a attached, through a slot in outer ring 5, to the inner edge of ring 4, the inner ring of the two nested, concentric rings 4 and 5 that extend around the perimeter of the blade system of this invention.

Inner ring 4 is supported for circumferential rotation in step with blade segments 1, through the interior of outer ring 5, by engaging multiple air inflated tires on outer ring wheels 20 that drive power generating equipment distributed at regular intervals around the interior of outer nested ring 5. If needed, idler wheels, not shown, can be interspersed between wheels 20 in the numbers needed to keep inner ring 4 moving smoothly through the interior of outer ring 5.

An alternative arrangement eliminates the inner nested ring 4 and instead uses the blade system to drive rotation of tires on wheels that move with the blade system while bearing on appropriate surfaces of the remaining ring 5, but this alternative seems likely to make the transfer of power output from tire/wheel driven generators to ground level much more difficult to accomplish reliably, and could eliminate wheel driven compression of air for energy storage.

In FIG. 2, tension maintenance in the array of wind force absorbing stay cables 7 is achieved by terminating the front (windward) end of each stay cable 7 with a tensioning device, 21 mounted on a shield 22 that is rotatably mounted within a collar 23 located at the point of convergence of stay cables 7 at the upper end of each diagonal spar 8. Vibration of stay cables 7 can be suppressed by surrounding their termini with viscous material. If additional damping is needed, adjacent stay cables 7 can be held together for that portion of their lengths where they run nearest each other, by means of cable clamps. (7a) having a viscous damping action, without substantial effect on the adjustment of tension in individual members of grouped stay cables 7 by tensioning devices 21 mounted on shield 22, within collar 23.

Wind force that is exerted on the outer nested ring 5 may require perimeter stays. 7b that extend fore and aft from outer nested ring 5 to terminate on the same diagonal spar mounted collars 23 that support rotation of shields 22 in synchrony with rotation of fore and aft sets of stay cables 7, along with the blade system.

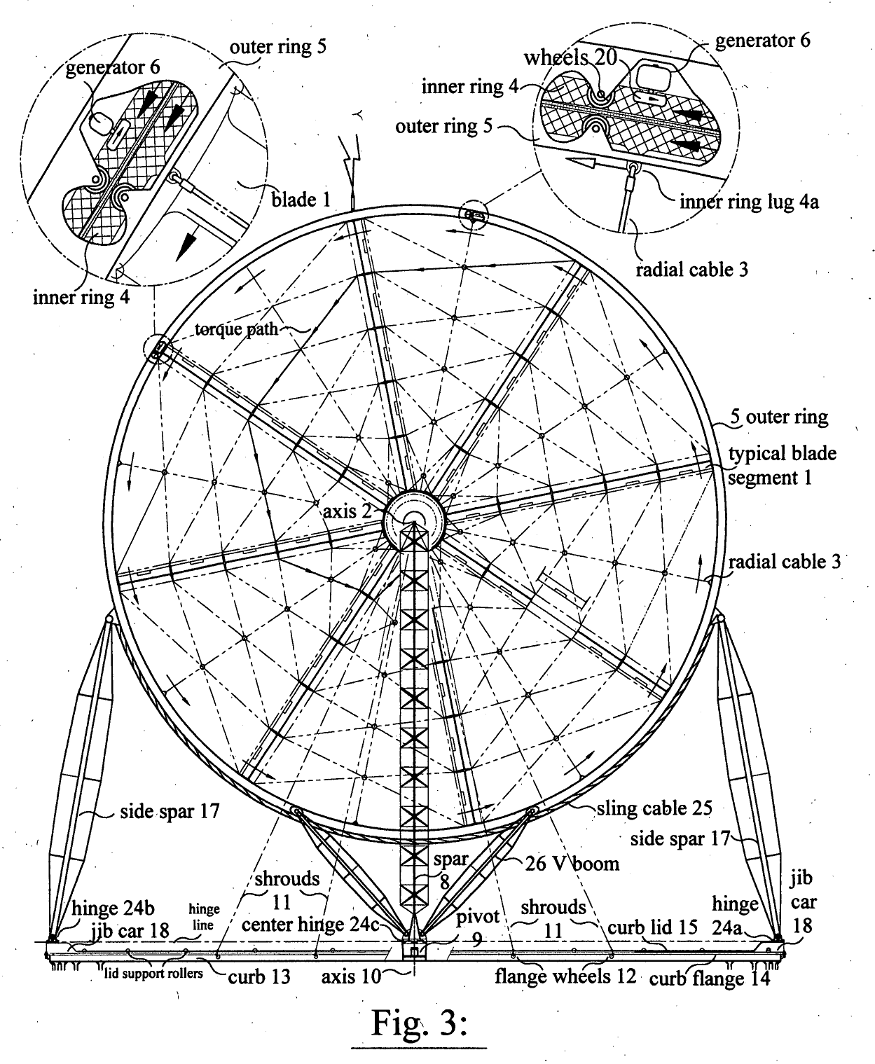

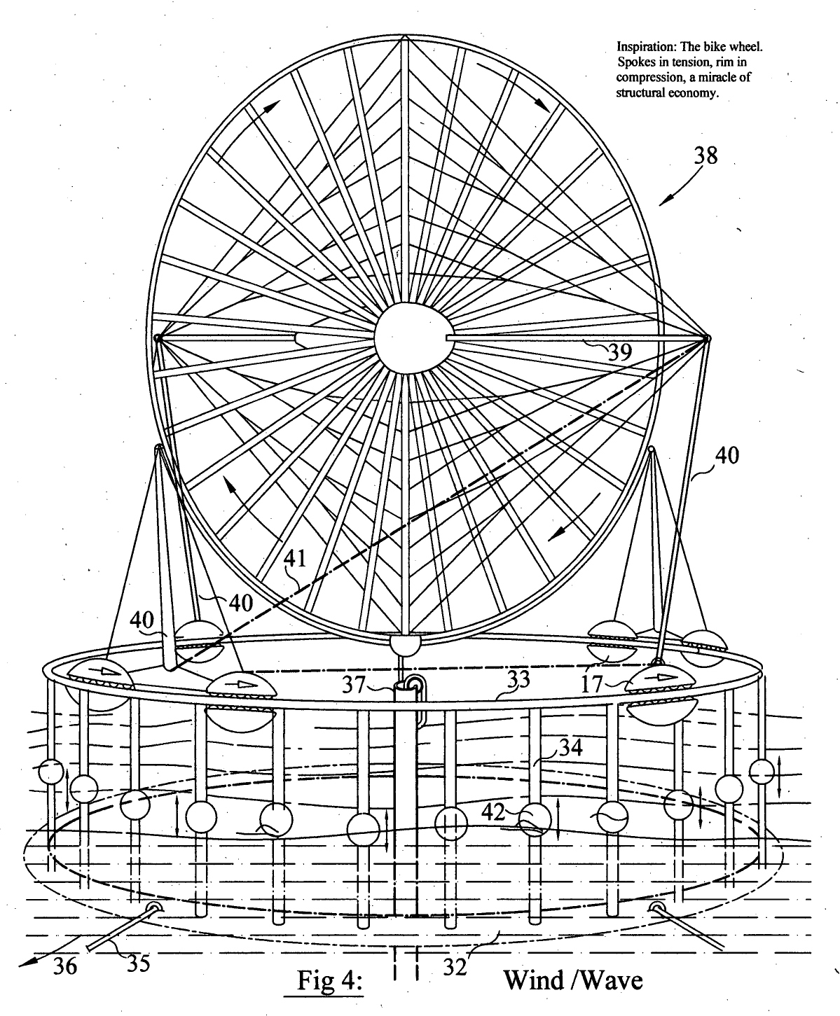

FIG. 3 offers a frontal view, showing how for greater ground clearance, nested rings 4 and 5 can be supported on a sling cable 25 that hangs between the tops of two side spars 17, which in turn rise from jib cars 18, up near to lateral quadrant locations on outer ring 5. Jib car 18 mounted hinge mechanisms 24a and 24b, in conjunction with a center pivot mounted hinge 24c, will still allow the blade system of this, invention to be lowered from a vertical to a horizontal position for maintenance, and to reduce public annoyance when this wind turbine fails to rotate for lack of wind. Two smaller, V shape booms 26, extend from center pivot 9, via hinge 24c, to appropriate points along outer ring 5 that will prevent any displacement of the blade system away from vertical axis 10.

The wind turbine structure described above can be modified for offshore use as shown in FIG. 4, by supporting nested rings 4 and 5 on a circular crib-like arrangement of two horizontal rings 32 and 33, separated by multiple vertical columns 34, wherein the lower ring 32, and columns 34 have sufficient water displacement volume to support the weight of the entire structure to a depth which submerges lower ring 32 completely and columns 34 to an appropriate portion of their lengths to enable their use in recovering energy from transiting waves. Cables 35 moor this floating structure to the ocean floor. If greater resilience to severe storms is needed, sag weights 36 can be added to cables 35. A separate tower 37, if centrally positioned within this floating structure, can provide a protected means for sending a useful power output down to the sea bed for its further transport to shore and the point of use.

Ring 33 at the top of columns 34 can then support wind turbine structure 38, by means which allow rotation of structure 38 into the current wind direction. This may consist of supporting the weight of wind turbine structure 38 on multiple, interconnected jib cars 18 that travel along the upper surface of upper ring 33.

Wind turbine structure 38 differs from the land based version of this invention in requiring a replacement for diagonal spars 8 as a means of absorbing wind force exerted on the blade system via stay cables 7. This may consist of: 1) a blade rotational, axis spar 39 that extends horizontally between opposite focal points for stay cables 7, 2) four nearly vertical spars 40 whose lower ends rest on jib cars 18 and whose upper ends converge in pairs at the two focal points for stay cables 7, and cables 41 that interconnect the foregoing elements into a structure that can rotate in azimuth into the current wind direction, and that will prevent the blade system from collapsing forward, should the wind suddenly reverse direction.

A major concern is that an extreme wave could exert enough lateral pressure on submerged ring 32 and columns 34 to overstress the sea bed anchoring system. This possibility can be minimized by:

1) Submerging ring 32 to a sufficient depth to greatly diminish ring motion in response to the passage of a storm wave,

2) By placing “sage” weights on tower anchor cables 35 at a suitable point along each cable in the direction of the arrow 36, so that greater resilience is offered to wave side force exerted on lower ring 32 and column 34.

Optionally, the rotation of inner nested ring 4 by the blade system may be used to drive rotation of air compressors as well as generators, in order to compress air for transmission to tower 37 and from there transmission to underground storage via passage through a volume of eutectic salt that is stored within tower 37, for later recovery to meet system demand for electrical energy. Optionally, submerged ring 32, and partially submerged columns 34 can support means 42 for extracting energy from wave motion in the surrounding water body, to supplement energy derived from the wind.

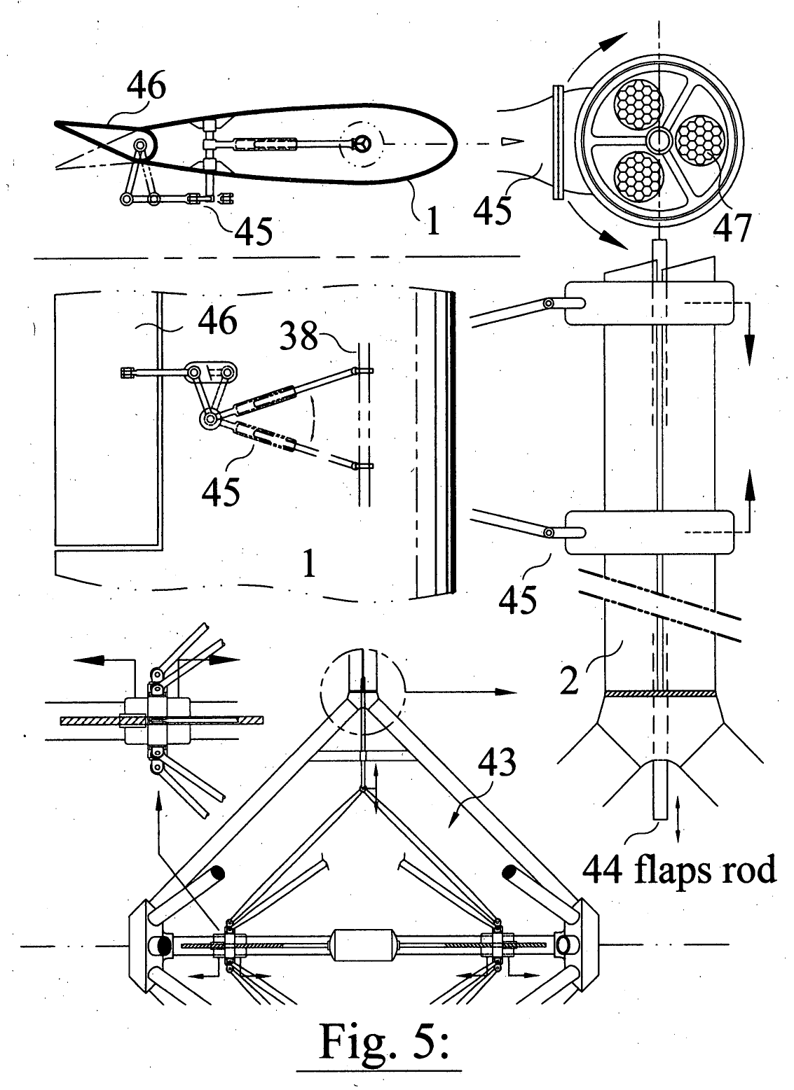

Many novel wind turbine blade systems are made possible by this invention. For one example, FIG. 5 shows how a central scissors mechanism, 27, can induce radial motion of rods 28 that in turn, through linkages 29, rotate the trailing edge elevators 30 of all blade segments 1 to achieve a uniform angle of incidence to each blade segment's local airflow, for the purpose of recovering maximum energy from the wind.

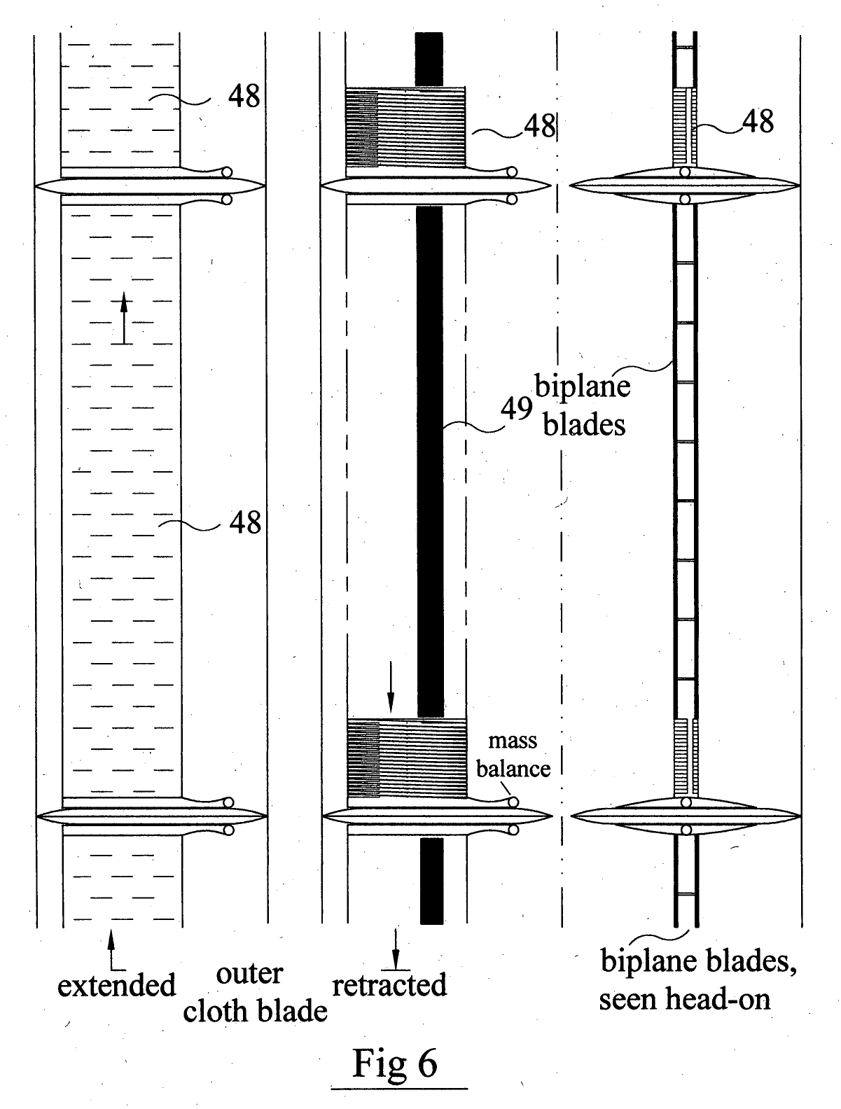

As a second example of the novel blade system made possible by this invention, FIG. 6 shows how blade segments 1 can consist of impact air inflated cloth blade segments for light winds that envelop much smaller chord biplane blade segments 31, that 1) are able to resist stronger winds, and 2) can be made to resist a substantial portion of the centripetal component of stay cable tension that would otherwise be exerted on perimeter nested rings 4 and 5.

I claim:

1. Means for reducing the weight of wind turbine structure needed to extract energy from the wind, comprising:
a) Multiple blades, so supported within a space frame type structure that said blades can be far lighter in weight than blades of comparable size for a conventional horizontal axis wind turbine, in part by designing said blades in the form of multiple sequential segments supported on tensional members that extend radially outward under tension from a common horizontal axis of rotation to at least one perimeter ring whose design in turn allows said blades to force the extraction of power from the wind at a far higher initial RPM than the RPM of airfoil rotation.
b) In a first such arrangement for taking off a useful power output, said tensional members extend out from a horizontal axis of rotation to a perimeter ring that has a typical rectangular cross section whose inner side has a centrally located gap that extends completely around said inner side of said perimeter ring, and that allows said airfoils to drive rotation of inflated rubber tires on wheels that run circumferentially along the inner and outer ring surfaces to either side of said centrally located gap. Rotation of said tires is then used to force the rotation of electrical generators and air compressors (?) at a far higher initial RPM than the rotation of the attached blade system. However, this first arrangement seems likely to incur problems in transferring the energy output of said electrical generators and air compressors down to ground level.
c) In a second such arrangement for taking off a useful power output at the outer ends of the blades, said perimeter ring encloses a second, internal ring to which the ends of the blade connect, through said centrally located gap, to drive rotation of this second, internal ring through the interior of said perimeter ring that encloses said second, internal ring. This second, internal ring is then used to drive rotation of wheels attached to power producing elements distributed at intervals along the interior of the outer perimeter ring, as a means of producing a useful power output at a high initial RPM that is more readily transferable, via the outer perimeter ring, down to ground level, for transport to the point of use.
d) In a second means for reducing turbine blade structural weight requirement, multiple stay cables extend from said blades, at intervals along their length, fore and aft to ancillary structure that can resist the wind's force with substantially greater economy of structure than is possible for the blades and tower of a conventional, cantilever beam blade wind turbine.
e) A first part of said ancillary structure for resisting the wind's force may consist of fore and aft spars whose upper ends are the termini for stay cables converging from the blade system, and whose lower ends rest on a central, ground level pivot.
f) A second part of said ancillary structure may consist of shroud cables that extend from the upper end of each diagonal spar down to mobile connections to an above ground level curb.
g) A third part of said ancillary structure may consist of an above ground level curb that encircles said pivot at the base of the nested rings, at the radius of the upper ends of the diagonal spars, in order to support mobile means for resisting stay cable tension.
h) A fourth part of said ancillary structure may consist of curb mounted jib cars having wheels that pull upward on a suitable element of the curb's cross section, for the purpose of resisting stay cable tension while remaining directly below the outer ends of this invention's two diagonal spars, as these spars rotate in azimuth with the blade system.

2. The horizontal axis wind turbine structure of claim one, with modifications and additions needed for successful offshore use, comprising:
a) A central tower secured to the sea floor to provide mans for transmitting a useful power output down to the seabed,
b) A submerged, toroidal flotation member in a horizontal orientation, surmounted by multiple hollow vertical columns, have together sufficient water displacement volume to support the weight of the remaining structure of this invention at a suitable height above sea level, and anchored to the sea bed to place the central tower at the center of said vertical columns,
c) Means appended to the vertical columns for recovering energy from waves as they transit these columns,
d) A second toroidal member that caps the vertical columns and serve to support structure for recovering energy from the wind,
e) A wind turbine having substantially the structure described in claim 1 above, whose weight is supported on said second toroidal member by means allowing said wind turbine to rotate into the current wind direction.
f) Means appended to an off-shore, upper toroid mounted wind turbine structure for driving rotation of air compressors as well as electrical generators. The air thus compressed might be delivered to the central tower, for subsequent storage in an underground reservoir, and subsequent retrieval to supplement energy currently available from wind and wave.
